(19) United States
(12) Patent Application Publication
(10) Pub. No.: US 2014/0316793 A1
(43) Pub. Date: Oct. 23, 2014

(54) SYSTEMS AND METHODS FOR RECRUITING AND MATCHING PATIENTS FOR CLINICAL TRIALS

(71) Applicant: nPruv, Inc., Del Mar, CA (US)

(72) Inventor: Brad Pruit, Del Mar, CA (US)

(21) Appl. No.: 14/214,653

(22) Filed: Mar. 14, 2014

Related U.S. Application Data
(60) Provisional application No. 61/785,803, filed on Mar. 14, 2013.

(51) Int. Cl. G06F 19/00

(52) U.S. Cl. CPC G06F 19/363
USPC 705/2

(57) ABSTRACT

Systems and methods provide for recruiting and matching patients for clinical trials using a network-based software platform which publicizes clinical trials, recruits patients for participation in the clinical trials, and obtains patient profile information to match patients with appropriate clinical trials based on medical and behavioral compatibility. Patients may be recruited to join clinical trials through online networking and referrals using social media and other electronic communication managed by the software platform. The software platform provides a user interface where patients can input profile information, search for clinical trials and view interactive clinical trial information pages. Patient profile information and clinical trial information may be used to generate a match score which indicates a patient's compatibility with a particular clinical trial and a compliance score which indicates a patient's likelihood of success in participating in the clinical trial.

### BACKGROUND

1. Technical Field

The embodiments described herein relate to recruiting and matching patients for participation in clinical trials, and more particularly to a clinical trial recruitment system which uses targeted recruiting and publication information to obtain potential patients which are then evaluated to determine patient compatibility and compliance for a clinical trial.

2. Related Art

In the biotechnology and pharmaceutical industry, a critical part of drug development, genetic therapy and even medical device product development involves conducting a clinical trial, which is a carefully-managed medical test of a potential drug, therapy or device on a group of patients over a period of time. The clinical trial will generate information on the efficacy of the drug, therapy or device, as well as safety information on side effects and adverse reactions. Clinical trials are required in many countries before a drug, therapy or device can be used. In many cases, the clinical trial must provide certain levels of positive results if a drug, therapy or device is to be approved by a government agency for use by the general population.

Clinical trials are often conducted at a clinical site (medical practice office, hospital or specialized clinic) and require periodic participation by the patients over a long period of time, from as little as a few days to many years. The patients are required to come to the clinical site numerous times for long periods of time to receive treatments and be tested to determine the results of the treatments.

As a result, finding patients to participate in the clinical trial is a significant challenge. A clinical trial must find patients who appear to be suffering from a condition which the drug, therapy or device is intended to treat. Finding a specific population of people in a high enough concentration within one area may be exceedingly difficult, and convincing an eligible patient to participate is yet another challenge. Many clinical trials provide monetary incentives from a few hundred to several thousand dollars to participate in a clinical trial. Even when a group of patients that meet certain criteria are enrolled and begin a treatment, patients may drop out or quit participating for any number of reasons. For example, some patients may not be able to follow the rigorous treatment and examination schedules, while some patients may enroll in a clinical trial simply for the monetary benefit and otherwise be a bad candidate for the particular clinical trial being conducted.

As a result of the above, along with numerous other factors, patient recruitment consumes more time and money than any other aspect of drug development. Due to patent term limitations, delays from insufficient patient enrollment and delays in clinical trials can cost drug companies anywhere from $600,000 to $8 million of revenue each day a drug launch is delayed. Given that 81% of trials are delayed 1 to 6 months due to patient enrollment problems, clinical trial sponsors and clinical (or contract) research organizations (CROs) are desperate for solutions to improve and streamline the clinical trial process.

The pharmaceutical and biomedical research industry is being challenged by skyrocketing clinical trial costs hampered by a shortage of patients, fewer drug approvals and limited growth in the number of available clinical investigators. Currently, the current cost of developing and bringing a new drug to market is over $1 billion. Large Phase III clinical trials enrolling an average of 5,000 patients may cost $400 million. An increase in the number of trials across the board means that more and more drug companies sponsoring clinical trials need to attract the best-performing CROs, clinical sites and physician investigators (PIs) to increase their odds for success, which only drives prices for CRO services even higher. Likewise, finding CROs and sites that are not recruiting against themselves by running similar studies is proving challenging—and thereby expensive.

At approximately 10-30% of clinical trial total budget, patient recruitment—the largest single driver of clinical costs—has been a challenge for clinical development teams for decades. Although patient recruitment represents up to one-third of the total clinical trial costs, few companies actually prepare for recruitment expenses or implement best practices to accelerate the patient recruitment process. The highest clinical trial cost drivers are patient recruitment costs and vendor fees, according to a study on clinical operations. On average, the largest clinical cost drivers are:
Patient recruitment: 32%
Vendor fees: 25%
Site recruitment: 14%
CTMS(Clinical Trial Mgt. Systems) and other technology: 12%
Site retention: 8%:
Data management and validation: 7%
Patient retention: 2%

In addition to the increasing costs and delays, patient recruitment for clinical trials is also failing for four reasons: 1) lack of awareness of patients who do not know of or know how to participate in a clinical trial; 2) lack of participation among the patients in need, as only 1% of patients who could benefit actually participate; 3) lack of time of physicians, as they are overwhelmed by thousands of patients and tens of thousands clinical trials recruiting at any given time; and 4) lack of autonomy for patients, as physicians generally control the enrollment of patients in clinical trials through direct recruitment at the clinical sites.

The biotechnology and pharmaceutical industries are therefore in need of ways to not only reduce the costs of clinical trials, but to also reduce delays in patient recruitment while also obtaining patients which provide the best chance for an accurate result and study completion.

### SUMMARY

Systems and methods provide for recruiting and matching patients for clinical trials using a network-based software platform which publicizes clinical trials, recruits patients for participation in the clinical trials, and obtains patient profile information to match patients with appropriate clinical trials based on compatibility and compliance measurements. Patients may be recruited to join clinical trials through online networking and referrals using social media and other electronic communication managed by the software platform. The software platform provides a user interface where patients can input profile information, search for clinical trials and view interactive clinical trial information pages. Patient profile information and clinical trial information may be analyzed to generate a compatibility score which indicates a patient's compatibility with a particular clinical trial. Additional patient information may be used to generate a compliance score which indicates a patient's likelihood of completing the clinical trial.

In one embodiment, a method for recruiting and matching patients for clinical trials comprises method for recruiting and matching patients with clinical trials, comprising: recruiting one or more patients for participation in a clinical trial; evaluating the compatibility of the one or more patients with the clinical trial and generating a compatibility score; evaluating the compliance of the one or more patients with the clinical trial and generating a compliance score; and determining whether the one or more patients should be enrolled in the clinical trial based on the compatibility score and compliance score.

From this description, in conjunction with other items, the advantages of the said invention will become clear and apparent more so based upon the hereinafter descriptions and claims, which are supported by drawings with numbers relating to parts, wherein are described in the following sections containing the relating numbers.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 illustrates a system for recruiting patients for a clinical trial, according to one embodiment;

FIG. 2 illustrates a method of screening patients for a clinical trial, according to one embodiment;

FIG. 3 illustrates a method of recruiting and matching patients for clinical trials, according to one embodiment;

FIG. 4 illustrates a graphical user interface (GUI) of a screening application on a patient recruitment website, according to one embodiment;

FIG. 5 illustrates a GUI of several categories of clinical trials for selection by patients, according to one embodiment;

FIG. 6 illustrates a GUI of several categories of pediatric clinical trials for selection by patients, according to one embodiment;

FIG. 7 illustrates a GUI of an interactive clinical trial information page, according to one embodiment;

FIG. 8 illustrates another GUI of an interactive clinical trial information page, according to one embodiment;

FIG. 9 illustrates still another GUI of an interactive clinical trial information page, according to one embodiment;

FIG. 10 illustrates a method of interacting with the clinical trial information page to enroll, follow or share information on a clinical trial, according to one embodiment;

FIG. 11 illustrates a method of selecting an appointment for a clinical trial screening.

FIG. 12 is a block diagram that illustrates an embodiment of a computer/server system upon which an embodiment of the inventive methodology may be implemented.

FIG. 13 is a block diagram of a method for matching patients and clinical trials, according to one embodiment of the invention.

FIG. 14 is an illustration of an additional method for providing a user interface for a patient to select a matching clinical trial.

FIGS. 15-28 are illustrations of graphical user interfaces provided by the system during the matching process.

### DETAILED DESCRIPTION

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

Embodiments described herein provide systems and methods for recruiting and matching of patients for clinical trials. Patients are recruited through various methods to visit a clinical trial information website with a variety of graphical user interfaces (GUIs) that display information on available clinical trials and provide for patient interaction with the website and various clinical trial information pages. Through the patient interaction with the website, a patient profile is created, which, along with other patient information, can then be used to match patients with appropriate clinical trials and generate a match score reflecting the compatibility of the patient with a particular clinical trial. Additional patient information may be used to determine a compliance score, which refers to the likelihood that the patient will complete the clinical trial.

The use of social media networking for patient recruitment is nascent with limitless potential. Readily available health data on each patient may be stored, and the stored health data for eligible trial participants may be automatically matched with clinical trials that match their health state and or location. Doctors may also be alerted when one of their patients is a match for a trial. The systems and methods described herein use digital health data, social media and analytics to optimize patient recruitment and access to clinical trials. Voluntarily received patient demographic, health and life style information may be leveraged and combined with data from electronic health records and other sources to increase the speed, number and quality of patients recruited for clinical research.

The clinical trial recruitment system is set up to be a neutral host for any type of clinical trial from any company, and the emphasis of the recruitment system will be on helping a patient find the best clinical trial option.

### Patient Recruitment System and Method

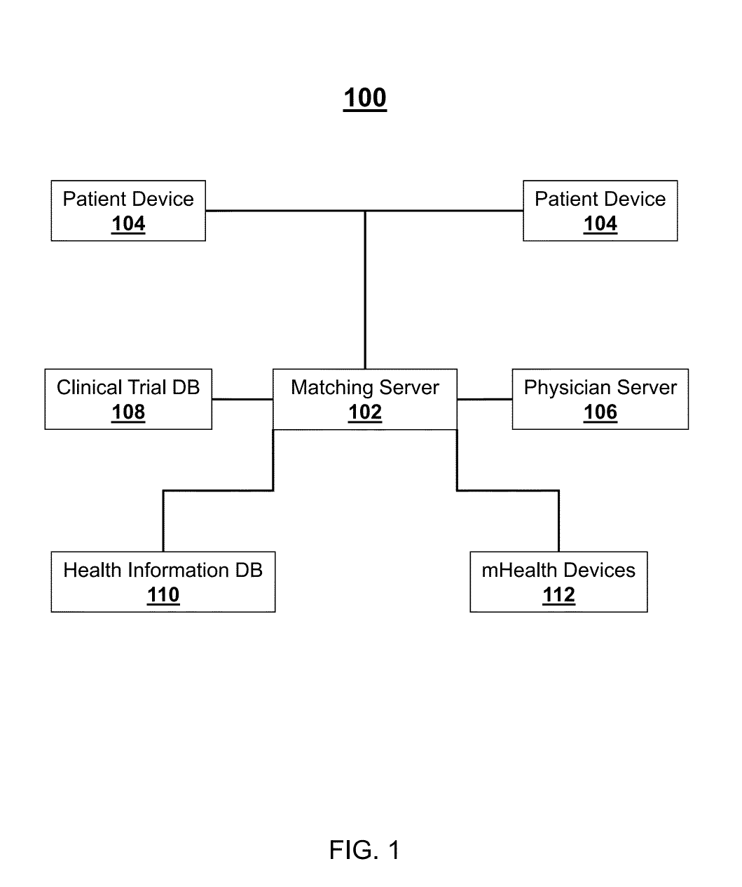

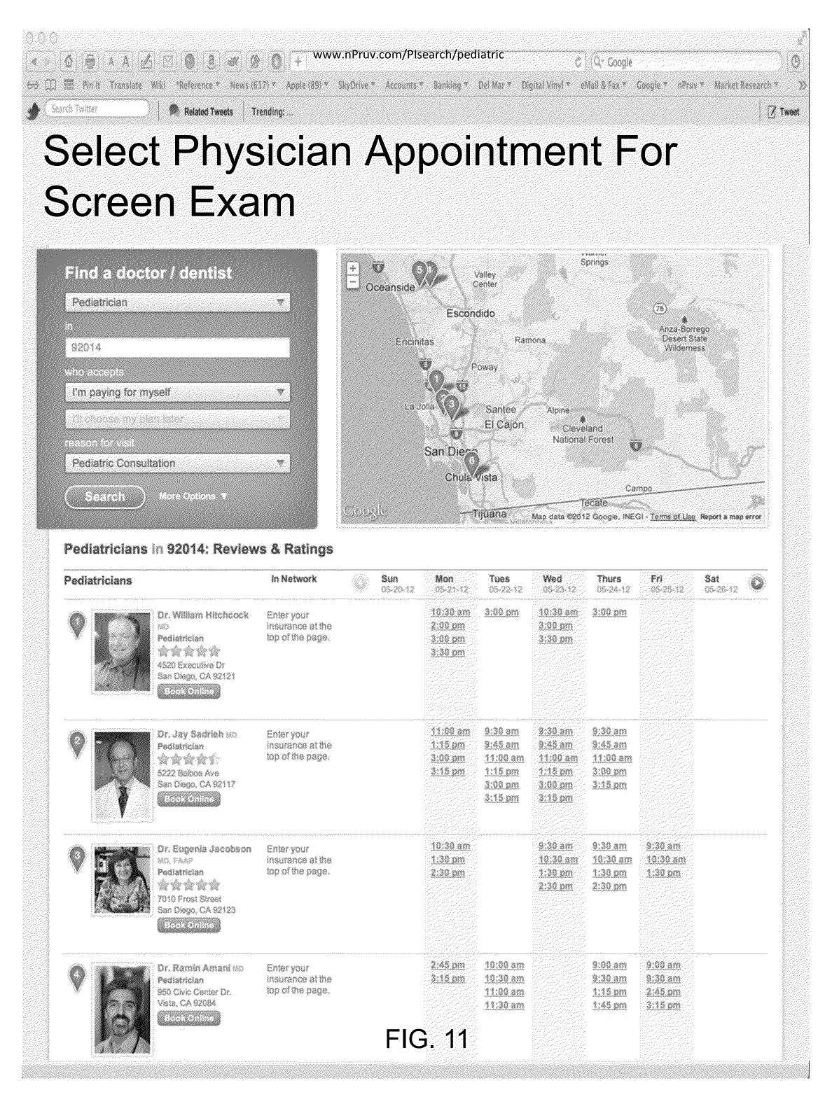

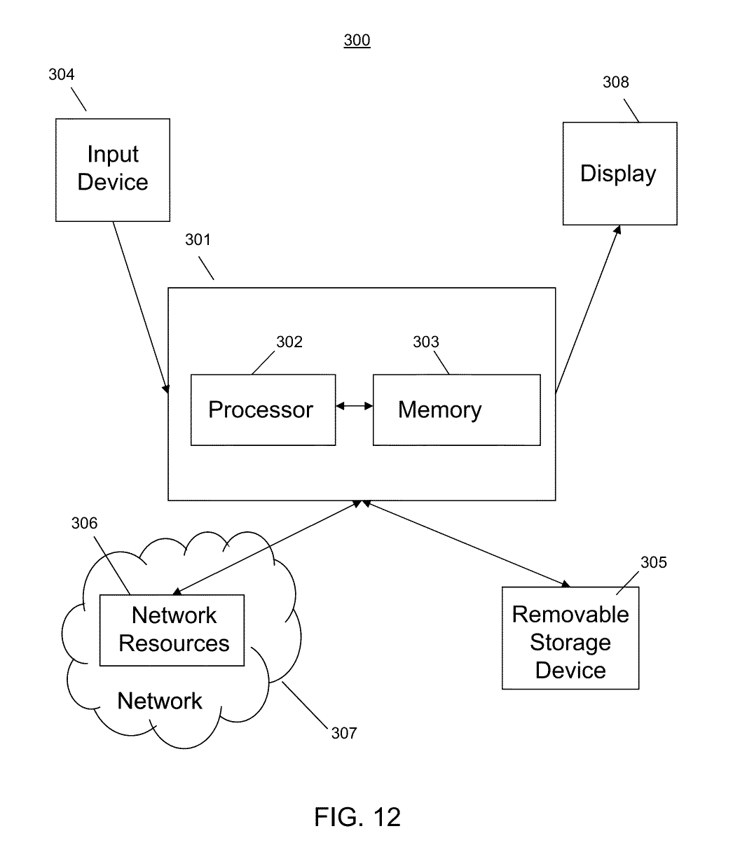

In one embodiment, a system 100 for recruiting and matching patients is illustrated in FIG. 1. A patient recruitment platform may be hosted and generated at a matching server 102, and be connected with one or more patient devices 104 which are used by patients to access the clinical trial information website at the matching server 102. In addition to being connected with the matching server 102, the patient devices 104 may also be connected with each other, enabling communication between patients with regard to potentially-matching clinical trials. The matching server 102 may also be connected over a network with a physician server 106 run by a physician, a clinical trial database 108, a health information database 110 or any type of mHealth device 112. Each of the servers, databases or devices may be a source of personal health information such as would be found in a clinic, hospital, etc. which has a plurality of patient information stored therein in the form of electronic medical records (EMRs) and Personal Health Records (PHR). Examples of the health information database 110 include a physician investigator (PI) database, a protocol database or Electronic Health Record (EHR) database. The patient information from the physician server 106 may be shared with the matching server 102 and used to improve matches between the patients and the clinical trials. Each of the matching server 102, patient devices 104 and physician server 106 may be embodied on a computer with a processor and memory, as is further described below with regard to FIG. 11.

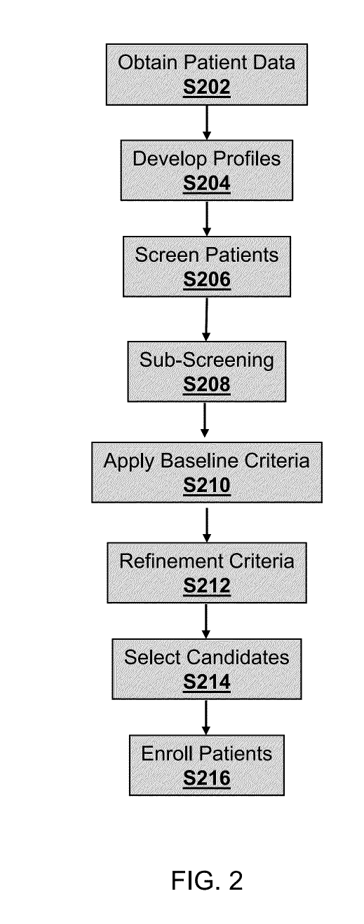

Patients will use the patient recruitment platform to identify and apply for clinical trials. As candidates apply for participation in the clinical trial, they are evaluated and screened to ensure that they are a good match for the clinical trial. Several steps of screening may be carried out to slowly narrow down the potential candidates to a select few which exactly match the type of participant that is needed for a particular clinical trial. FIG. 2 illustrates one embodiment of a method of screening patients for a clinical trial. First, patient data is obtained in S202, after which a patient profile is developed in S204 which is then used to perform an initial screening step S206. For example, a first screening step may include basic tests, like demographic data, a patient's diagnosis, previous medical conditions and any test results. The screening steps may be as specific as looking at a genomic profile to determine if a candidate possesses a specific genome sequence that is relevant to the treatment being performed in the clinical trial. Clinical trials may require a specific sub-set of patients with unique symptoms or conditions in order to determine the effectiveness of a particular treatment or device, and so numerous screening steps may be needed. In FIG. 2, an initial screening step to screen all patients is followed by a sub-selection step S208 which has narrowed down the entire group of candidates to only 20. A set of baseline criteria pertaining to the specific physiological or symptomatic conditions needed for the clinical trial is then applied in step S210, which further narrows the candidate patients to only 5. In a further refinement step S212, even more specific criteria may be applied to identify specific levels of compounds in a patient's body. These further refinement steps may require information not included in a patient's profile information and therefore require the patient to come to a physician's office for specific testing of the patient. After this further refinement step, only the few patients that remain are selected in step S214 and enrolled (S216) in the clinical trial.

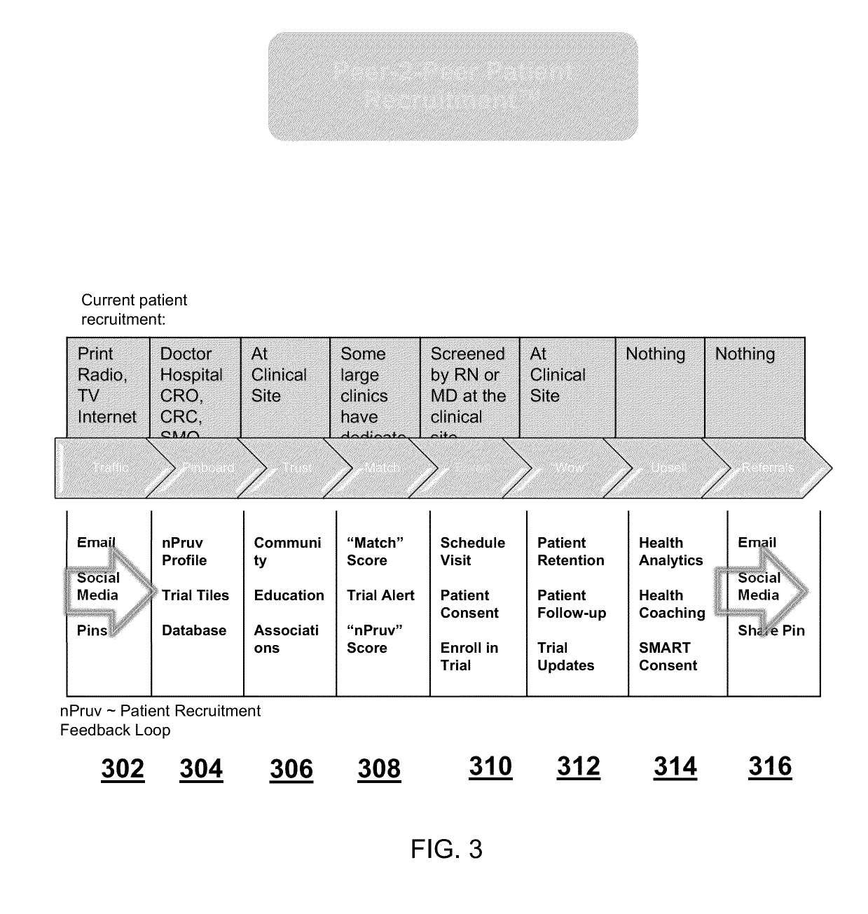

FIG. 3 illustrates one embodiment of the overall method of recruiting and matching a patient with a clinical trial. Beginning with the left side of the diagram, overall recruitment of patients begins with marketing and publication techniques, such as advertisements in print, radio, television and the Internet (302). These marketing efforts may also include the tools provided to patients within the patient recruitment system 304, including sending messages from one patient to another, posting information about a clinical trial to a board or message board of specific patients, and publication over social media. E-mail blasts may be sent out to an overall list of patients who are interested in clinical trials, or to doctors, hospitals and clinics that have patients who may be interested in enrolling in a clinical trial.

Any leads captured during this initial process are then taken for further processing within the system to build trust 306, such as having the candidate patient review the information on the clinical trial available at the clinical trial website. The candidate patient is also able to communicate with a person knowledgeable about the clinical trial to have any questions answered. This additional level of information provided to the candidate will build trust between the candidate and the clinical trial and help to attract more candidate patients.

Next, at 308 the patients who are interested in enrollment are evaluated based on patient profile information to determine both a “match score” and a “compliance score” (shown here as an “npruv score”). These scores will be described in further detail below. These scores will provide a simple numerical value reflecting the likelihood that a particular patient will be a successful participant in the clinical trial. If the patient is a match, an alert may be sent to the patient indicating their approval and asking that they enroll.

Approved patients may then enroll 310 by scheduling a visit at the clinical trial location or with a physician who will carry out a further examination of the patient to make sure they are appropriate candidates for the clinical trial. The patients who are finally enrolled and begin participating in the clinical trial are still provided with services 312 from the patient recruitment system, in terms of communication with the clinical trial sponsors or physicians, messages with updates and scheduling for trial participation, evaluations of the clinical trial, reviews and other feedback.

At the end of the clinical trial period, the patient may still be provided with additional services 314 to ensure that they remain interested in the patient recruitment system. These services may include overall health analytics, coaching, and rewards and incentives for evaluating the trial and the physician. The patient is then motivated and incentivized to share their experience in the clinical trial 316 with others via the website, social media, messaging and other communication methods. By generating positive patient experiences, patients will increase the publicity of the website and the potential patient base from which the clinical trials select their patients.

### Interactive Clinical Trial Platform

In one embodiment, an interactive clinical trial platform may be provided in the form of a web-based application such as a website hosted at the matching server and accessible by patients on their patient devices. The website may provide information on numerous clinical trials which the clinical trial sponsor has specifically uploaded to the website or which are aggregated from other content on the Internet, such as a clinical sponsor's primary website.

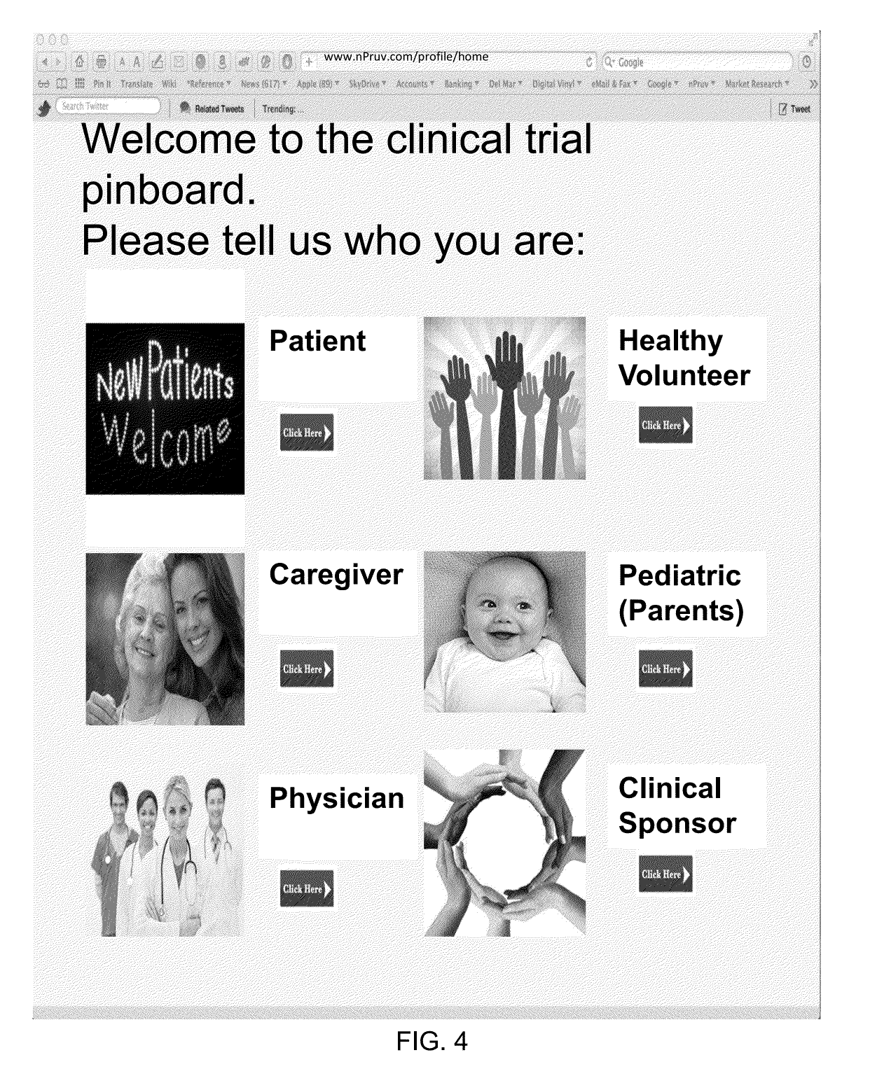

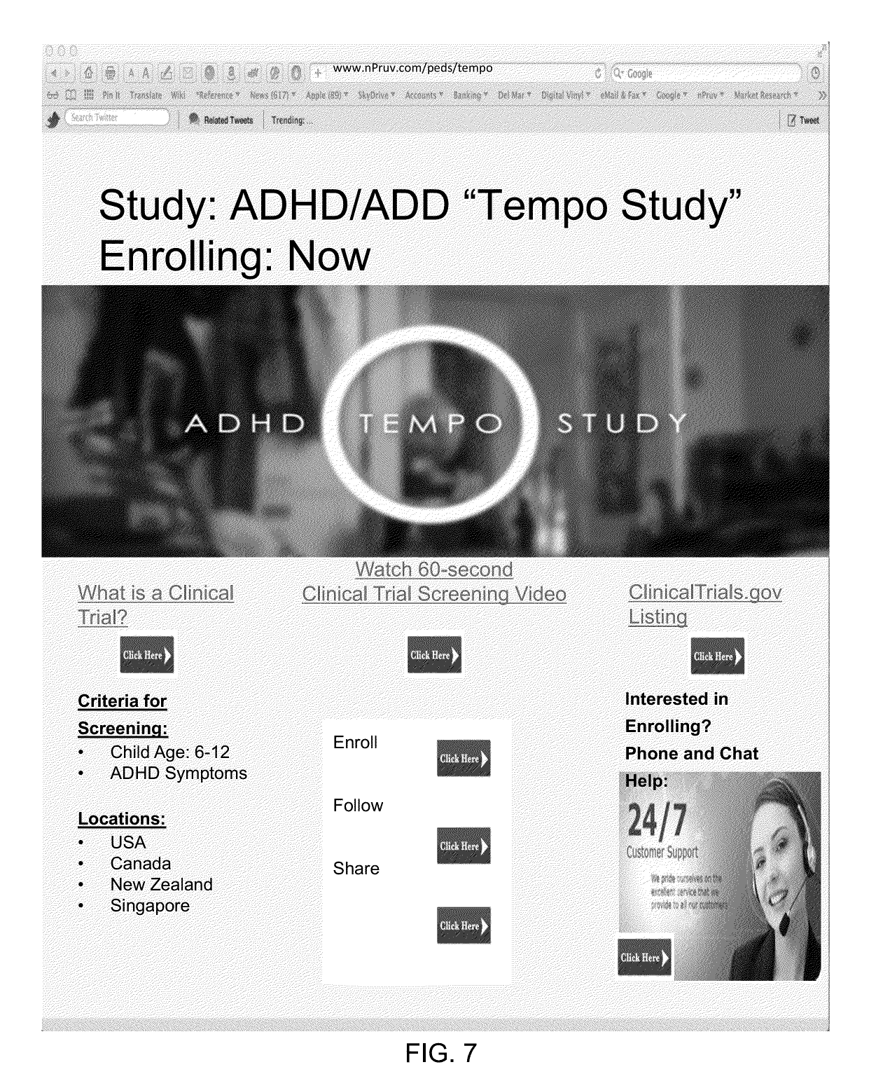

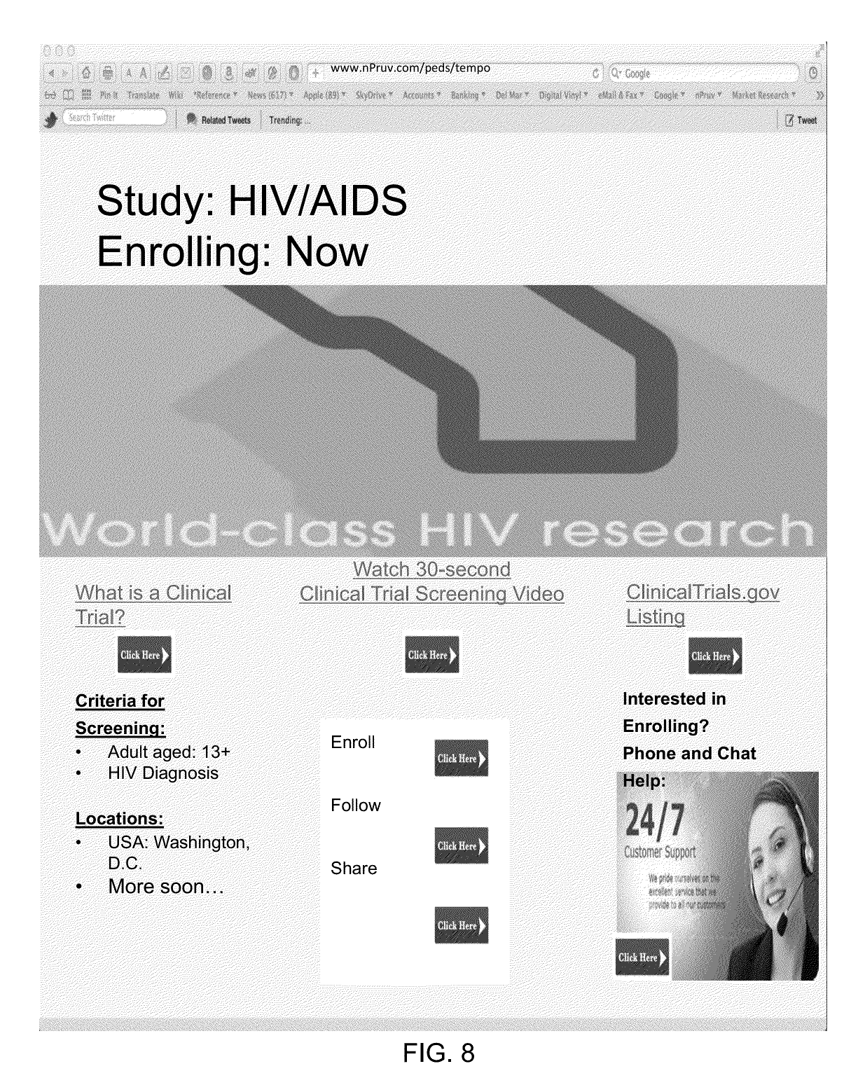

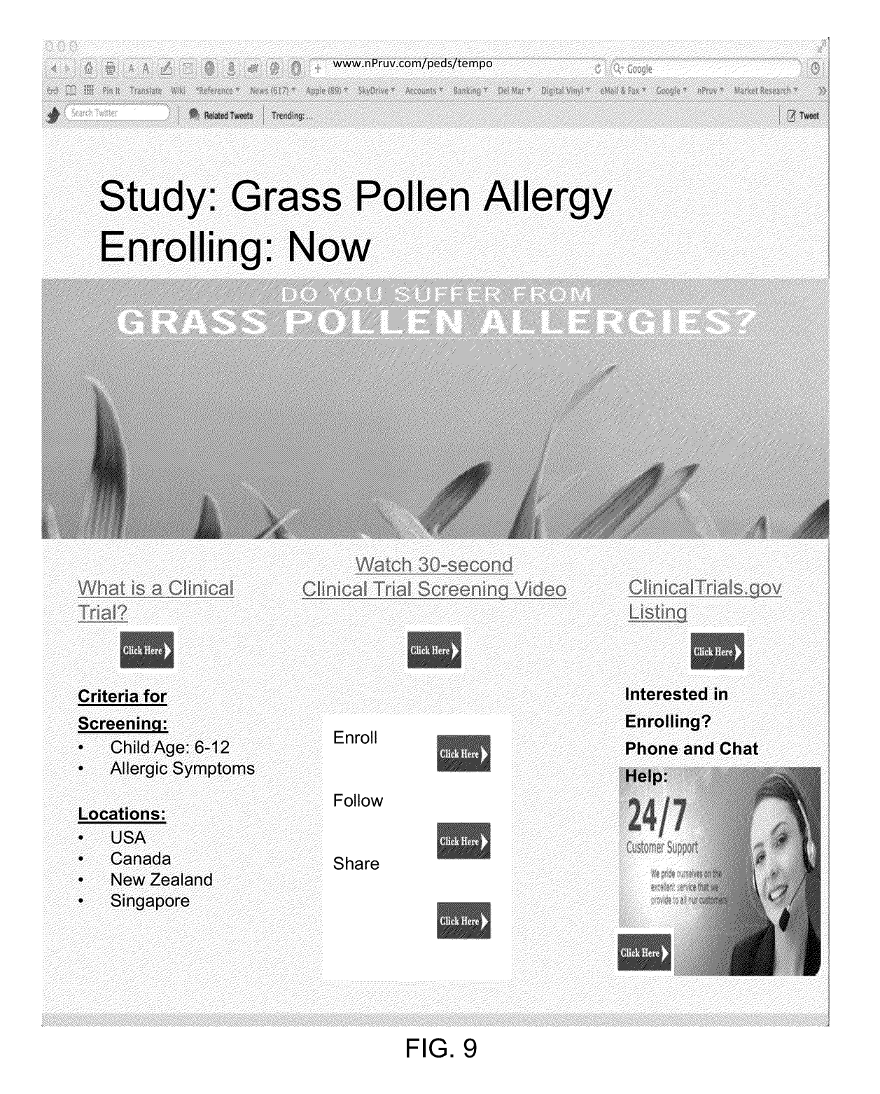

FIGS. 4-9 illustrate embodiments of a clinical trial information page that the website may provide for each listed clinical trial. The website will contain detailed, searchable information on the clinical trials and essentially advertise the clinical trial to a potential patient by providing details on the trial, including who should participate, the location of the trial, the length of the trial, the type of drug, treatment or device being tested, etc. However, the website will be a graphic-based style with visual appeal to the user as opposed to just a laundry list of information. The website may also host a video or other presentation that clearly explains the important information on the clinical trial that a potential participant would be interested in.

The website may also have search capabilities so that a patient visiting the website can search for a clinical trial based on a particular medical condition, based on a location of the user and the location of the clinical trial (proximity searching) and many other details relating to the trial, the patient and the treatment. In another embodiment, the website may present the patient with a screening application which helps the patient identify their symptoms, possible causes and other relevant health and medical information that will provide a more suitable clinical trial.

The website may be designed to guide users to appropriate trials through a series of menus provided on a graphical user interface (GUI) of the website, as illustrated in FIG. 4. In one embodiment, the categories of participants listed on a homepage of the website may include patients, healthy volunteers, caregivers, pediatrics, physicians and clinical sponsors. Each type of participant will select their corresponding icon in order to view a more specific page of information directed specifically to their group.

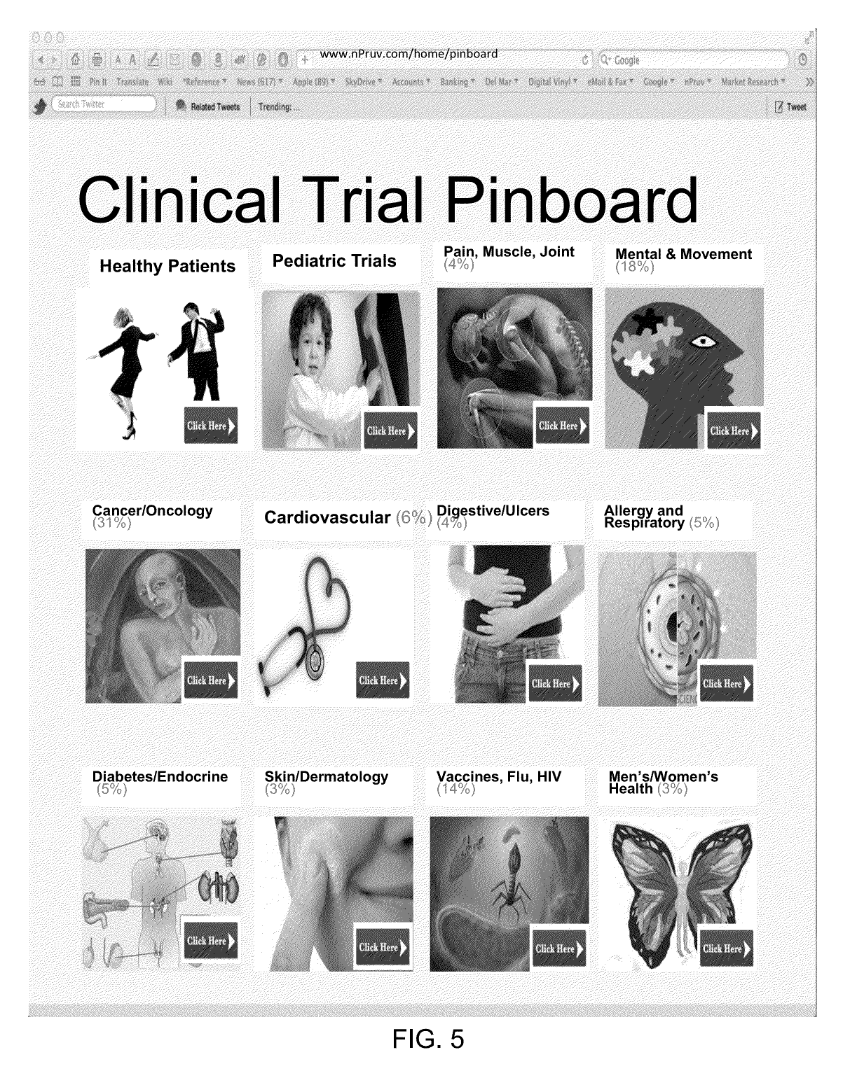

The website may also present a bulletin board of available clinical trials that are currently looking for participants, as illustrated by the GUI in FIG. 5. The clinical trials may be listed by category, or may just provide a hyperlinked thumbnail image or icon for each category so that a user interested in that category will select the thumbnail image to open a new page with more specifics on the particular type of clinical trials.

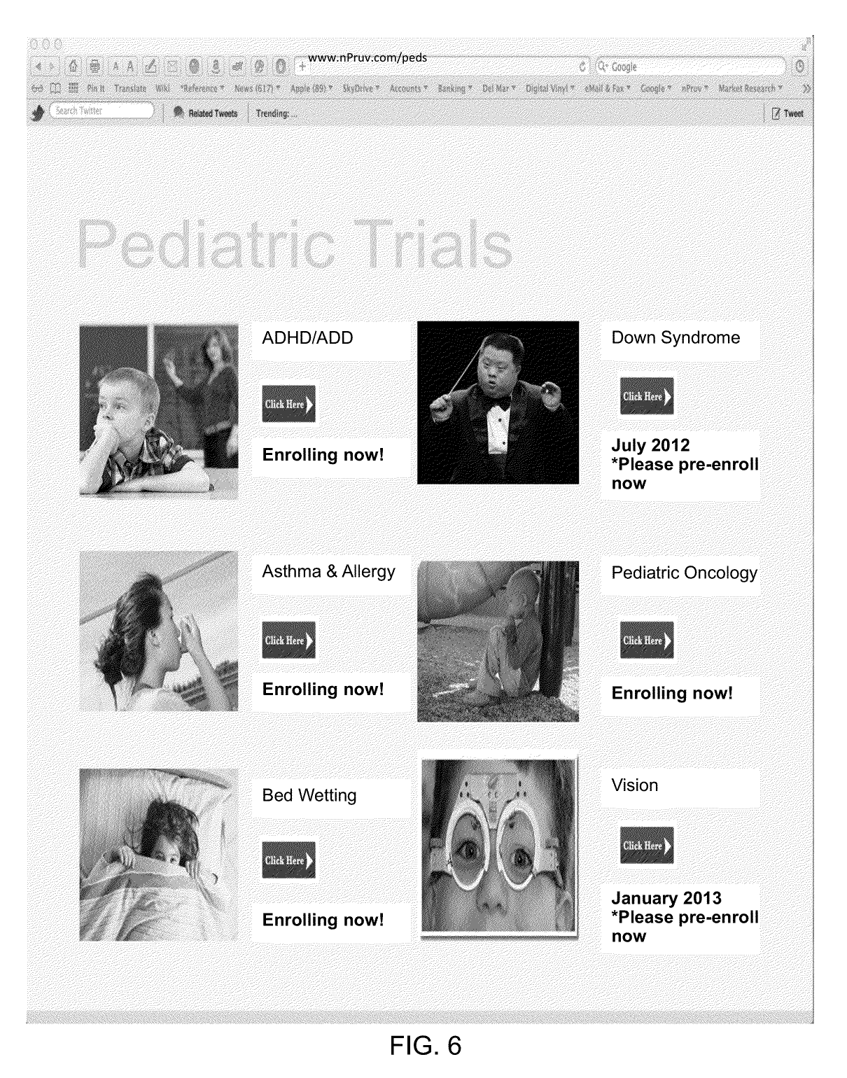

When a certain category is selected, another page will be provided with trials divided by additional more specific types, such as specific conditions, diseases or symptoms that someone is experiencing. For example, as shown in FIG. 6, selecting a category of “pediatrics” on the homepage in FIG. 4 or FIG. 5 will lead to another page where further categories such as “ADHD/ADD, Asthma and Allergy, Bed Wetting, Down Syndrome,” etc. are listed.

In one embodiment, the website may also provide categories for numerous types of conditions regardless of whether a clinical trial is available, in which case the user is provided with the opportunity to sign up for an alert for a future clinical trial. In another embodiment, the patient can sign up to receive alerts and updates on the enrollment process for the clinical trial so the user can have time to decide whether or not to participate in the trial. The data on how many users sign up for alerts for particular conditions or treatments may be used by a researcher or medical company to decide which new area of treatment to pursue.

In another embodiment, a link on the clinical trial page may also provide a user with the ability to chat or email with an expert who is helping administer the clinical trial and can answer further questions.

Once the patient has viewed the clinical trial information page and its content, the user may select to either “enroll” in the clinical trial, “follow” the clinical trial (for future announcements and news), or share the information on the clinical trial with another patient that may be interested, such as a friend or family member that suffers from the same disease.

At this point, a specific clinical trial may be selected and a new page with details of the clinical trial will be provided, including short videos explaining the trial, a list of eligibility criteria, links to other websites with additional information, and options for enrolling in the clinical trial, following the clinical trial, or sharing the clinical trial with someone else. The website for the clinical trial may also include a message board for potential participants to ask questions or for the current participants to discuss certain aspects of the trial. A communication tool may also be provided for direct communication with a doctor or clinician. A profile of the doctor or doctors running the clinical trial may also be provided so that a patient candidate can evaluate the doctor's history and expertise in a particular field.

### Recruitment and Sharing

The recruiting of patients by other patients and doctors is of paramount importance for the success of the patient recruitment system. Both patients and doctors may be involved in the recruitment of patients, as well as overall medical practices, hospitals and other healthcare facilities. Social networking, messaging through text, e-mail, instant messaging other messaging protocols may all be used by patients in order to share a particular clinical trial and generate a referral.

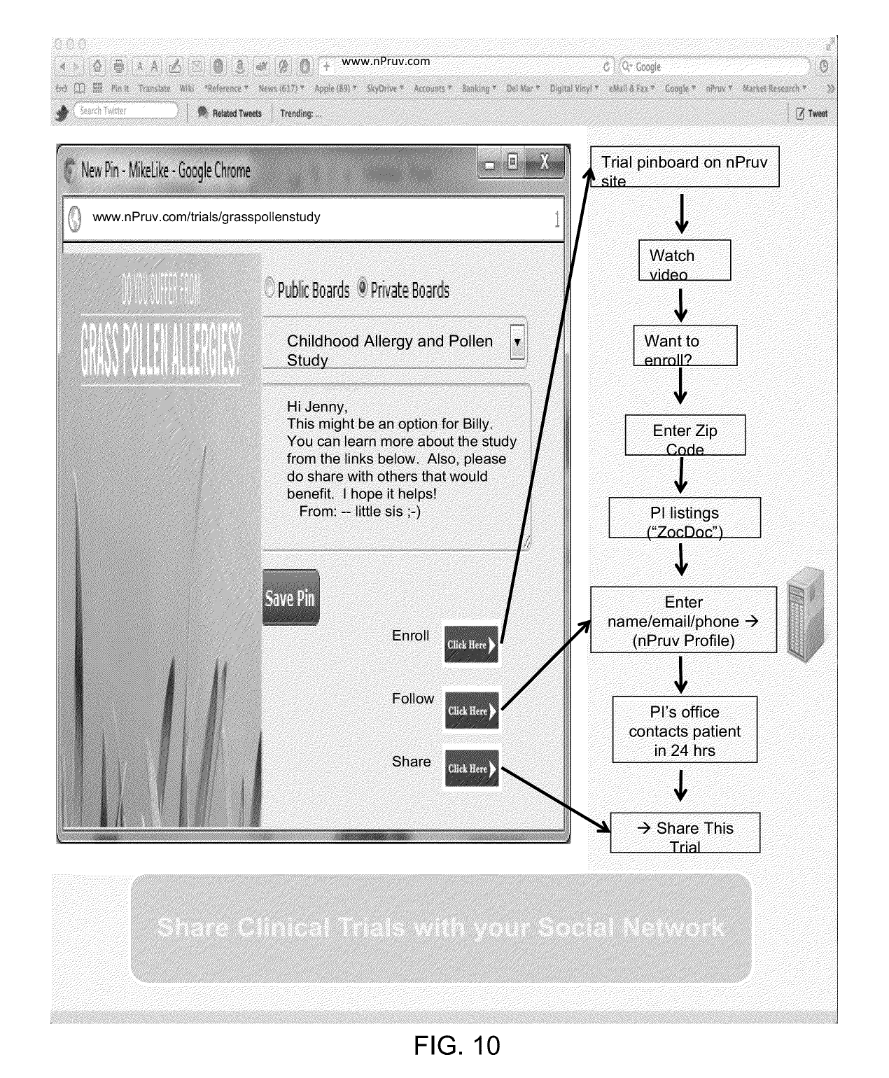

In one embodiment, the website may be configured as a social media tool where users and visitors can share information with each other on clinical trials. FIG. 10 illustrates one embodiment where a message can be created by one patient and sent to another patient suggesting that a particular clinical trial may be beneficial to the receiving patient.

In another embodiment, patients may be rewarded for certain activities related to recruiting other patients or providing feedback relating to their experience with a clinical trial. Users may be provided with rewards for referring a clinical trial to another user that ends up enrolling in the clinical trial or for participating in the clinical trial themselves. In another embodiment, a rewards system may reward a user for posting a hyperlink with information about the clinical trial on their social media page, broadcast feed, etc. if someone clicks on the hyperlink and enrolls in the clinical trial. Similarly, an advertisement for a clinical trial may be populated on a social media website next to a discussion about a particular condition or disease by using a media scrubber to extract user content from the social media website.

In one embodiment, a traceable “e-flyer” may be used as well, so that each person who views the e-flyer and clicks on the e-flyer to can be tracked in order to provide the appropriate reward to the user who originally posted or shared the e-flyer. Tiered rewards may be available to a variety of users depending on how close they are in the chain of referral to the ultimate end-user that signed up for the clinical trial. Options may be provided for users to send short emails or text messages using the website to potential candidates, further simplifying the process of sharing a clinical trial with another user or guest. The rewards may be any type of monetary or non-monetary reward, such as earning points for an online game, receiving gift cards or discounts, making donations to charity, etc.

The clinical trial recruitment system may also use targeted advertising to recruit participants, such as by populating ads when a user types in certain words in a search engine query or when a user uses certain words in an email, on a social media website, etc.

### Enrollment and Profiling

Once the patient has decided to enroll in a particular clinical trial, the system provides a streamlined and simplistic process where the patient completes a set of information on their health and wellness. The patient profile process may be performed by a screening application running at the patient device or the matching server which takes the patient step-by-step through a process of selecting different information about the patient's health, wellness and specific problems being experienced. During the enrollment process, a patient profile is generated which may include patient health data provided by the patient during an enrollment. The patient profile can also be populated with third-party medical information on the patient, such as Electronic Medical Records (EMRs) kept by the patient's primary care doctor at the physician server or personal health records (PHRs) or mHealth devices that monitor and record patient data (such as Zeo, Garmin or MS Health Vault).

In one embodiment, patient medical data from the patient's medical records or information provided by the patient may be used for the clinical trial recruitment system. The patient's medical data may be stored in a database at the physician server, which can be easily accessed by the matching server which can be searched by a company running a clinical trial to identify potential candidates for participation in the clinical trial.

To create the patient profile, a new user may then be asked to enter their personal profile information, such as their age, weight, height, medical conditions, eating and drinking habits, history or use of smoking, etc. Information on the patient's location may also be needed in order to customize the selection of available clinical trials to those within a certain city, county or region near the patient. The user may also be able to upload electronic medical records or give the website permission to request access to their EMRs from their doctor or some other type of accessible but secure database.

Detailed patient profile information, such as information on the patient's previous experiences in clinical trials, may also be obtained, as this type of profile information may also be useful to identify candidates for related trials on similar or alternative treatments.

The patient enrollment application may also provide an interactive scheduling tool which allows the patient to immediately see upcoming available times in which the patient may need to meet with the clinical trial sponsor or physician investigator (PI) to discuss the treatment.

Once the patient profiles are created, the amount of data collected during the patient enrollment process may be stored in a local database of the matching server. This large sum of data could be exploited in numerous different ways beyond the scope of patient recruitment, as the amount of collective health information available for such a large number of patients may prove useful to study for medical purposes, some of which will be described further herein.

### Match Score

In one embodiment, the candidates for a particular clinical trial can be ranked with a match score using a proprietary scoring system based on how well a candidate patient's profile matches the criteria for the clinical trial. The profile and criteria may include anything from the location of the patient and the location of the clinical trial to particular genetic code in the patient's genome. The screening process will quickly and easily screen patients for clinical trials based on inclusion and exclusion rules provided by a clinical trial sponsor, which will then be cross-referenced with the patient profile data, linked EMR/EHR data and other questions specific to a particular clinical trial. The match score represents a simple numerical value of all of these evaluations.

A match score represents a candidate patient's compatibility with a particular clinical trial based on a comparison of the candidate patient's profile information with the criteria and goals of the clinical trial. The clinical trial will list several criteria which set forth the type of patients needed for the trial, such as age, gender, symptoms, medications, etc. The criteria list is then compared with the patient profile information to determine how many of these criteria match the patient's profile information.

For example, if a study protocol needed patients with a minimum of 5 out of 10 criteria, such as being on a type of drug, having a body mass index above a specific number, etc., the match score is a direct correlation to the needed criteria. The match score may therefore be given as a ratio, such as 5 out of 10. Additional matches may be reviewed based on the location of the patient to the location of the clinical trial to ensure that the patient is close enough to the clinical trial to participate.

In another embodiment, a doctor, clinic or other health care professional or company may use the clinical trial recruitment system to analyze their lists of patients and patient profiles to identify potential participants in the available clinical trials. The doctor may be provided with a software application resident on their local network that can analyze electronic medical records to sort through the various conditions, symptoms and diagnoses for patients, compare them with the profile information on the clinical trials available and then make recommendations for which patients may be interested in or benefit from certain clinical trials. The system may be designed to work with the provider's electronic health records (EHR) and different formats for medical and genomic data. Alternatively, patient data may be uploaded to a remote server which securely stores patient data but which can also provide an analysis of the patient data against the available clinical trials to recommend certain clinical trials for certain patients that may be a good match. This patient matching service may also be automated to be carried out without the direct supervision or input of the doctor, which saves the doctor time while at the same time providing a greater service to the doctor's patients.

### Compliance Score

A compliance score, or “npruv” score, will assess a candidate patient's likelihood of complying with the requirements of the clinical trial and completing the clinical trial with an adequate amount of feedback. For example, if a patient has enrolled in 5 trials in the past but only completed 3 trials, the patient will be given a rating of 3 out of 5. The patients and the physicians will be provided with a score that is continually updated by proprietary algorithms to predict the likelihood of a patient: 1) entering a trial (enrollment), 2) being compliant (good data), 3) completing a trial (achieving a data point for the study), and 4) sharing trial information with a network (outreach ability of the user or physician).

The information used to determine the compliance score may be obtained from data on the patient reported by previous clinical trials, patient surveys, public data including correlated social media postings attributed to the patient and other user generated data.

In one embodiment, the physicians, sponsors or research group conducting the clinical trial can also be rated and provided with a compliance score by the patients participating in the clinical trial. This information can then be displayed on the clinical trial page for any future clinical trial conducted by that physician, sponsor or research group so that patients can see if the clinical trial has a good service or track record of conducting clinical trials. In addition, this information will be useful to sponsors looking for physicians and CROs to conduct new clinical trials.

In another embodiment, the clinical trial recruitment system provides for automated follow ups with a patient to evaluate their progress and make assessments. The system may also follow up with users that watch or never enroll in a particular clinical trial in order to determine why they did not enroll and make improvements to the system. The system may also specifically follow up with patients who dropped out of trials after they started, as this information may be critical when the trial sponsor is providing the clinical trial results to a government or regulatory agency.

### Patient and Trial Matching Process

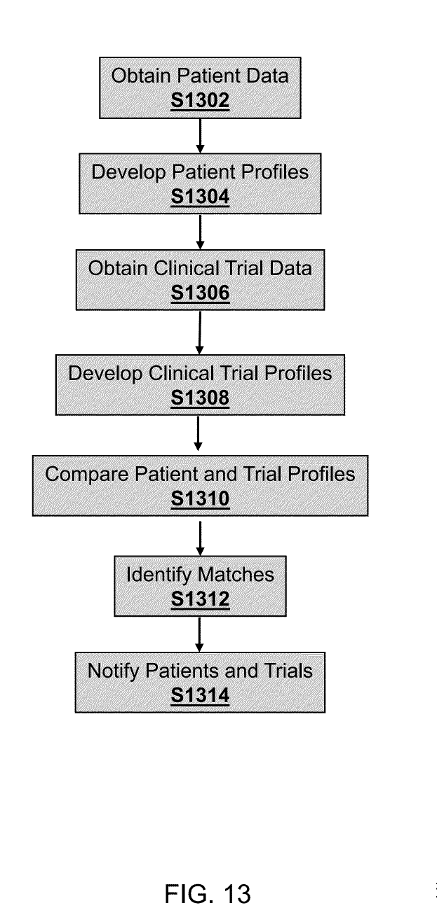

One embodiment of a method for matching patients with clinical trials is illustrated in FIG. 13, where patient data is obtained (S1302) and used to develop patient profiles (S1304). Clinical trial data is also obtained (S1306) and used to develop clinical trial profiles (S1308). The profiles are then compared (S1310) to identify similar categories and produce likely matches (S1312) based on the similarities in one or more categories of the profiles. Either the patient or the clinical trial is then notified (S1314) about the potential match, depending on which party initiated the request or which party is interested in finding a match.

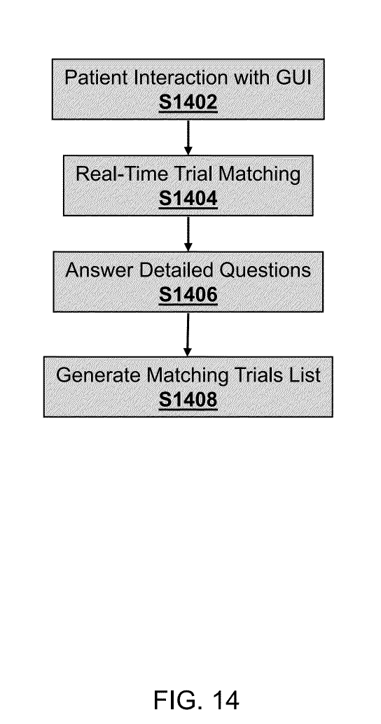

An alternate method of patient and clinical trial matching is illustrated in FIG. 14, where the patient is directed to interact with a user interface (S1402) in real time to answer general questions about health, disease, location, availability, etc., which is then used in real time to compare (S1404) with stored information on clinical trials and prompt the user to answer detailed health questions (S1406) based on their answers to the previous questions and based on any preliminary matching clinical trials. These detailed answers will then be used to determine one or more matching clinical trials (S1408) which match the information input by the user. In this alternate method, the user does not need to upload any personal health information or personally identify themselves, thus providing an easier method to obtain a match without requiring the use of EHR or other medical records which may be difficult to obtain or require regulatory hurdles to use.

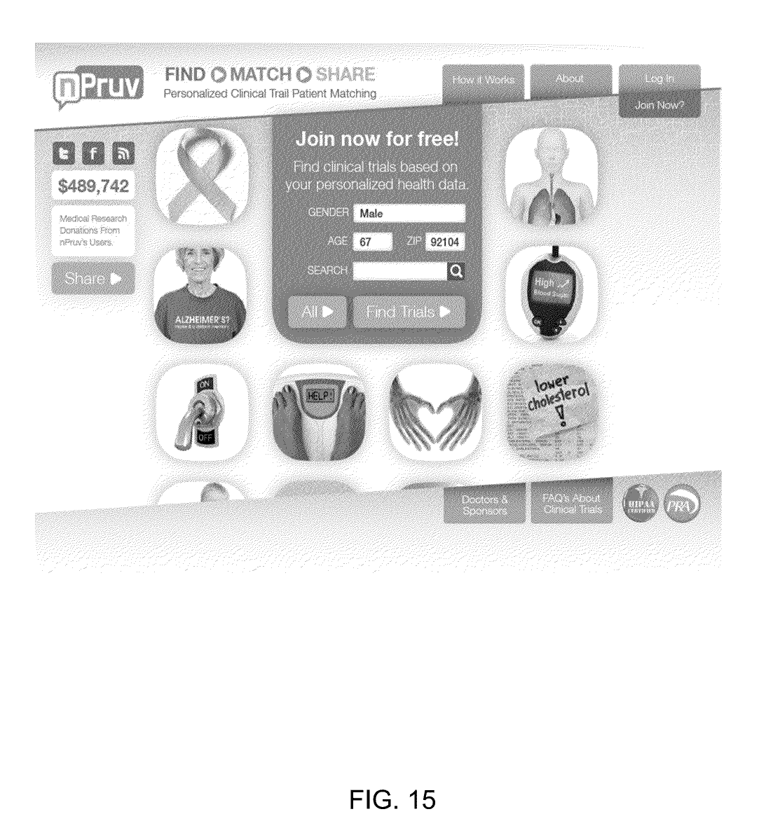

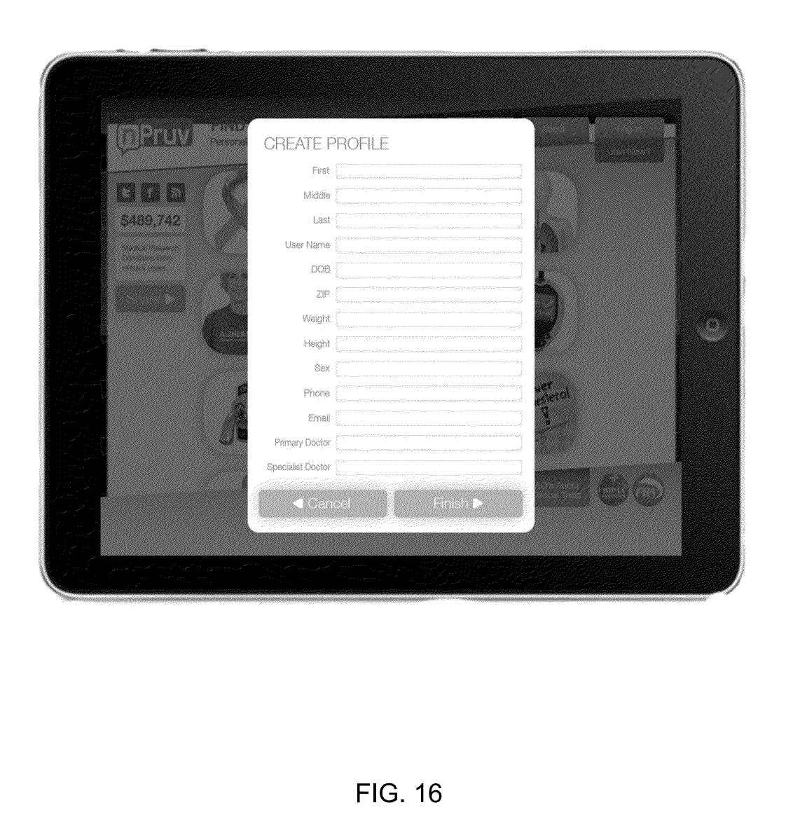

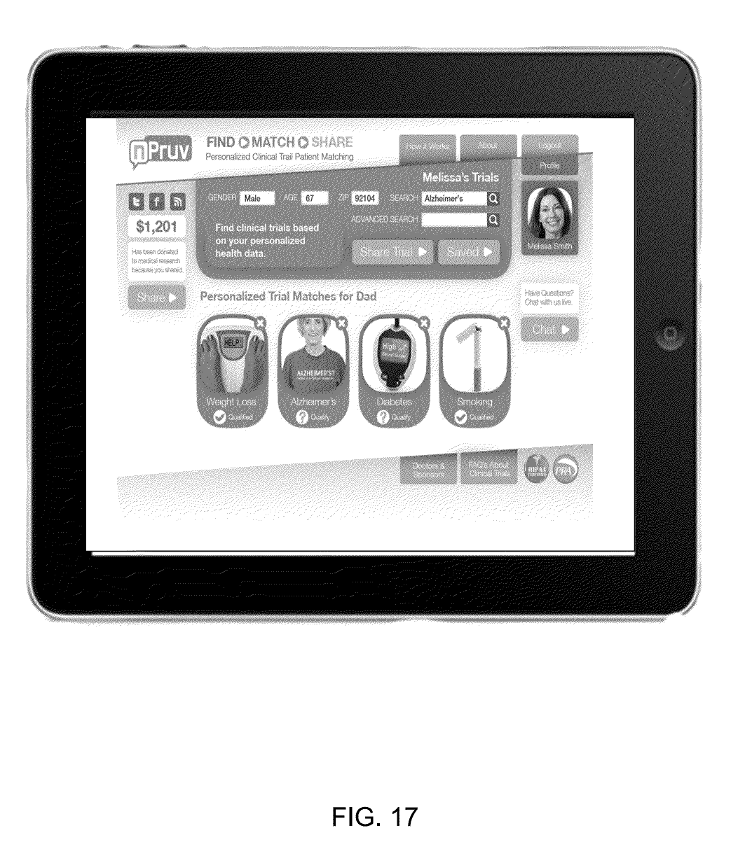

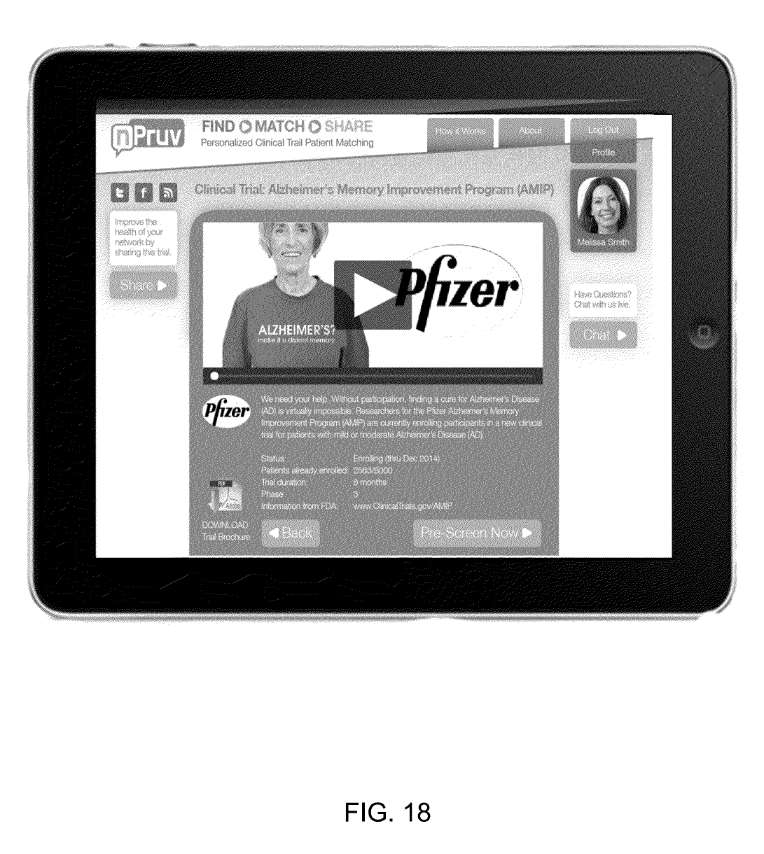

FIGS. 15-25 illustrate a graphical user interface (GUI) of a clinical trial matching process, according to one embodiment of the invention. In FIG. 15, a user is provided with different tiles for different types of diseases, symptoms, injuries, etc, and asked to create a profile (in FIG. 16) in order to begin the process. The profile screen may collect anonymous health information or location information to select a local trial. An initial match screen is illustrated in FIG. 17 and is generated based on the use profile created in the previous step. In FIG. 18, the user can select one of the trials and see detailed information about the trial, including the likely candidates, the length, location, compensation, etc. If the user is interested, the user can select to be “pre-screened” for the trial in order to see if they fit a specific trial criteria. Additionally, options to chat with an advisor are provided or share the trial information with a likely candidate. In one embodiment, the user's social media information and contacts' information may be utilized to suggest social media contacts in certain locations that may be interested in a clinical trial listed in the results.

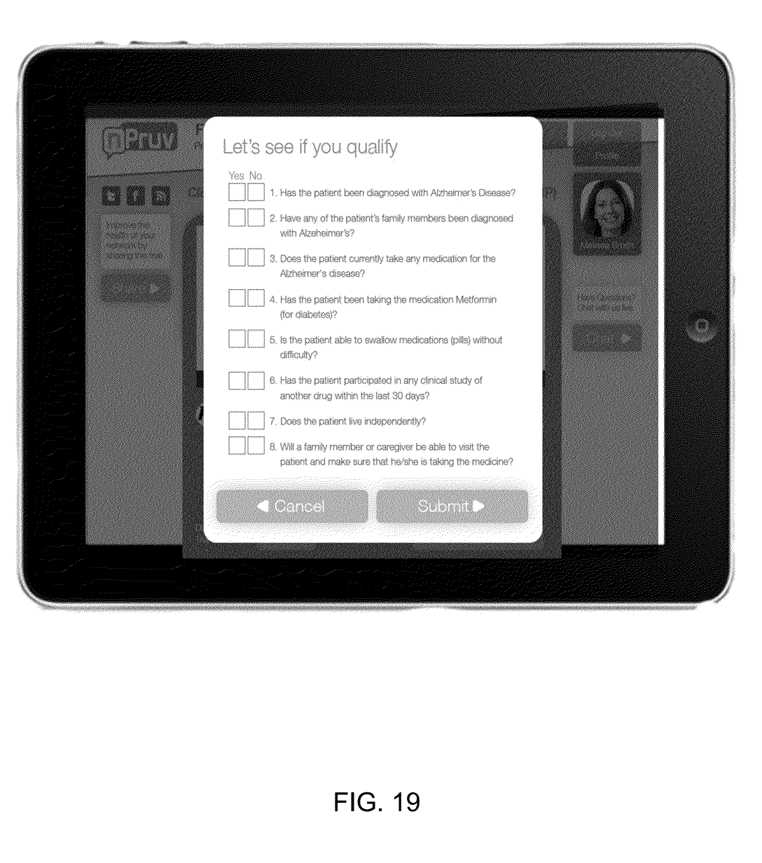

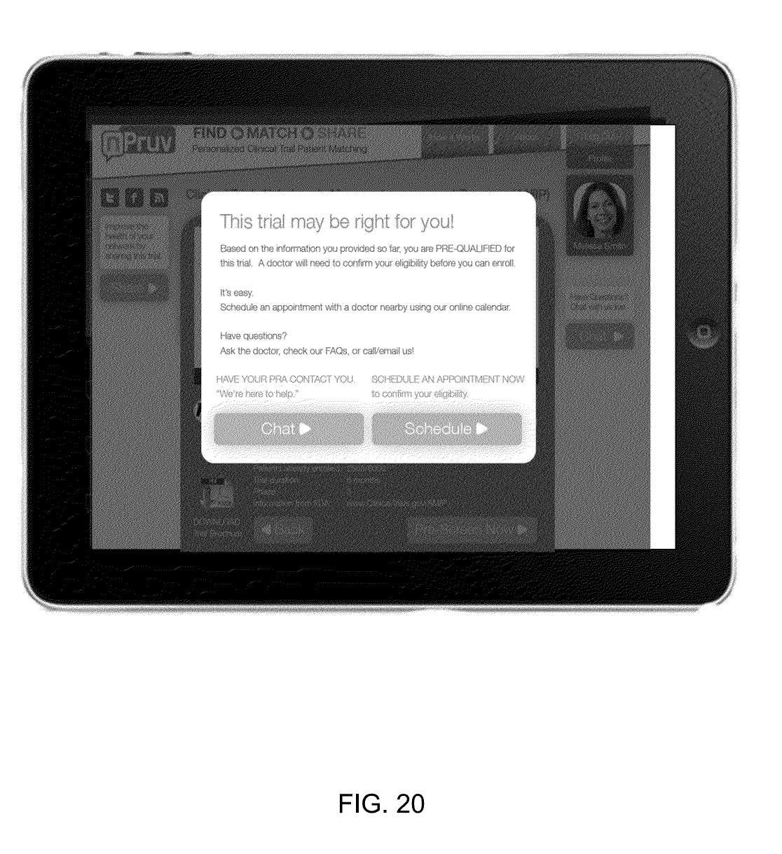

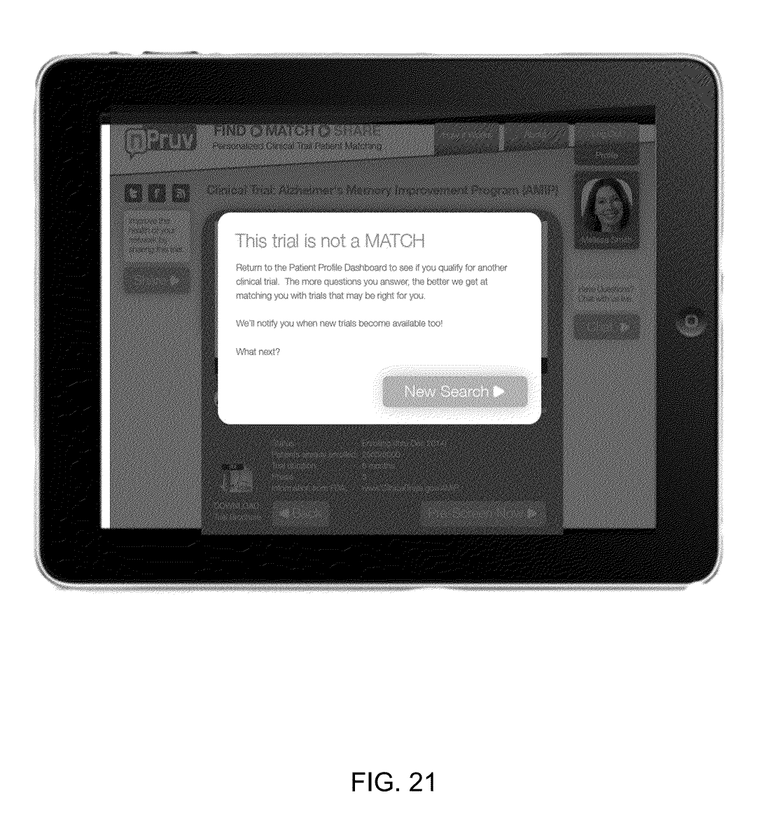

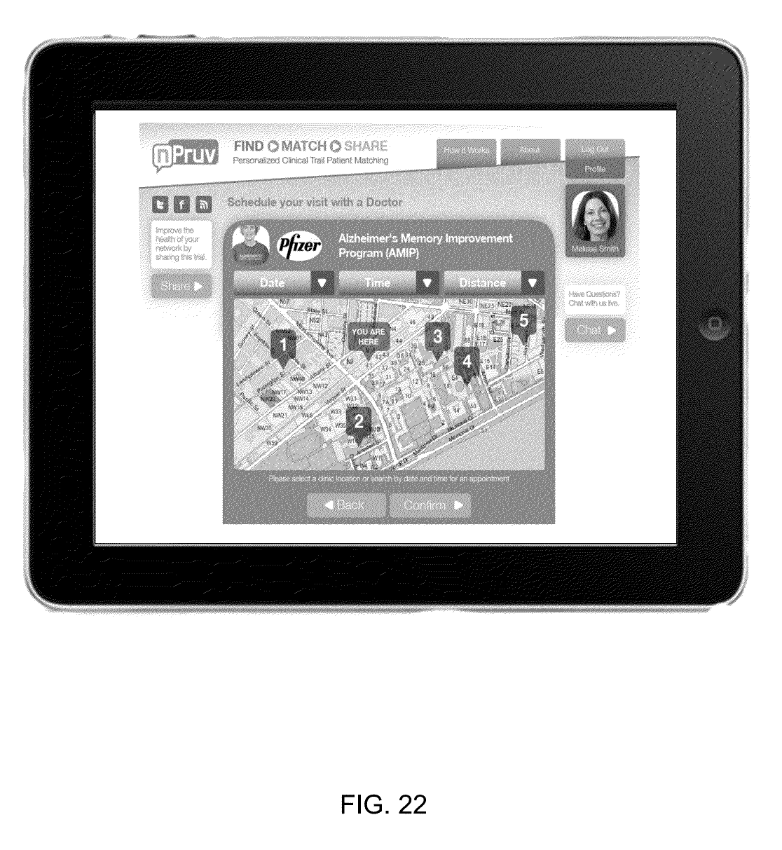

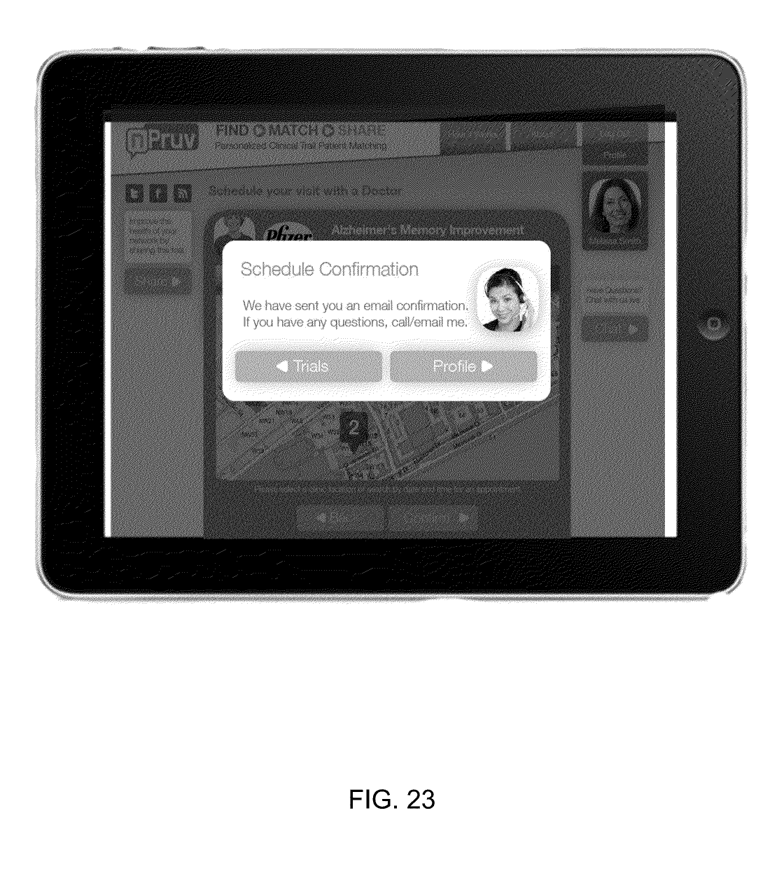

If the user decides to be pre-screened, detailed information is then collected (see FIG. 19) to determine whether the user meets the specific criteria for the trial. If the user is a match, a match screen is produced as in FIG. 20, inviting the user to chat with a representative to discuss enrollment, or proceed to enrollment and schedule an appointment with a PI. If the trial is not a match, the non-match screen in FIG. 21 is produced, inviting the user to re-run the match process. In FIG. 22, the user is shown the location of the trials to pick the best option for an appointment, and in FIG. 23, the user is given an interactive user interface to schedule an appointment.

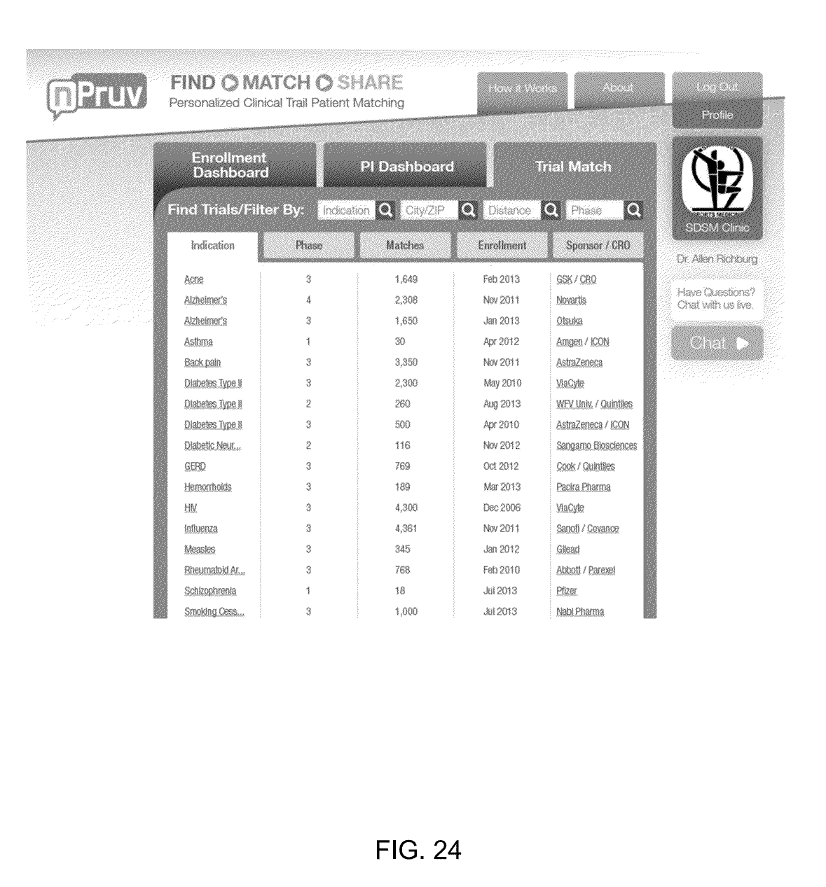

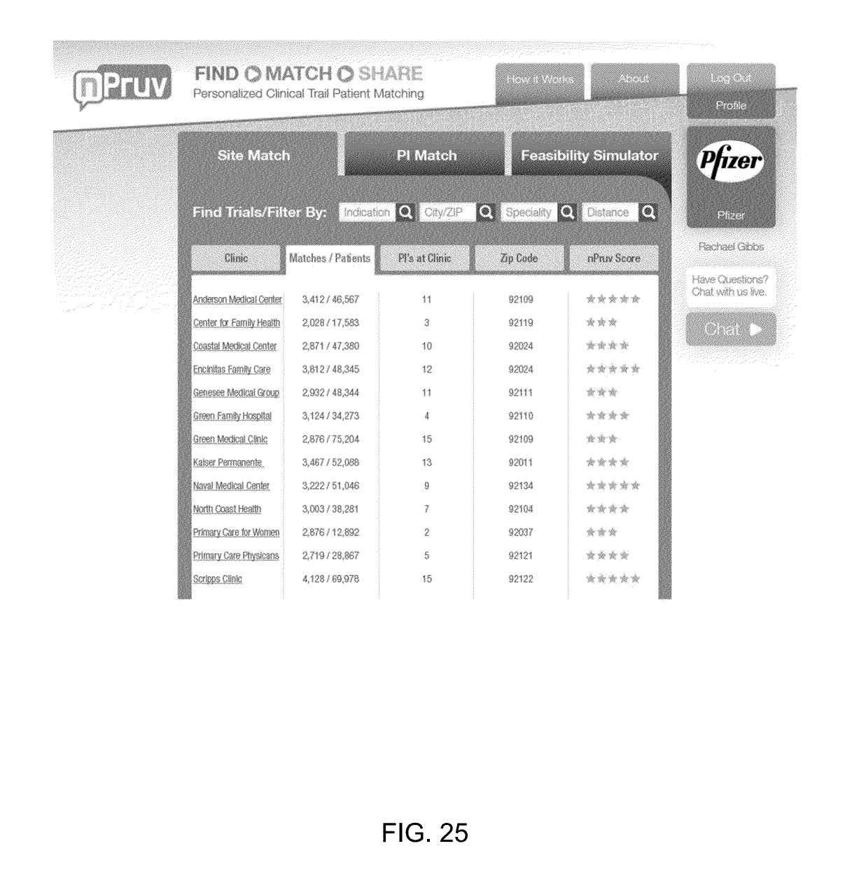

FIG. 24 illustrates a trial match tab which provides a detailed list of information on various trials, the status/phase of the trial, the number of matches that have been provided by the system for that particular trial, enrollment deadlines and sponsor/CRO information. FIG. 25 similarly shows a Site Match tab with detailed information on clinical trial sites, including the number of matches, total patients, number of PIs, location/zip code and the rating or score for that particular site, based on previous user ratings of the site.

### Clinical Trial Design & Feasibility Analytics

One benefit of the clinical trial recruitment system is the plurality of patient data which is collected, as this data can be used to not only find patients for existing clinical trials, but also to design clinical trials based on identified symptoms and conditions that are prevalent in the patient medical data. Similarly, the value of a potential clinical trial can be evaluated by determining how many potential patients there are in the clinical trial recruitment system database. A “test-run” of a clinical trial could even be conducted by searching the database of patient profile information to determine how many candidates exist for a given set of criteria of a proposed clinical trial. Sponsors of the clinical trial may then shift the location of the clinical trial or adjust their criteria to find a predicted set of patients that meets their minimum requirements.

A feasibility determination may also be made to determine whether a clinical trial is likely to find enough patients in a particular area or with a particular CRO based on patient and enrollment data that is stored in the system from previous clinical trials.

### Clinical Trial Analytics

In one embodiment, data can be obtained on the clinical trial based on past analytics of similar trials run by similar companies or physician investigators. The clinical trial sponsors and managers may be given ratings based on previous performance, which can then be utilized by the patients selecting the trials to determine which trial may be better managed and more likely to produce a potentially successful result.

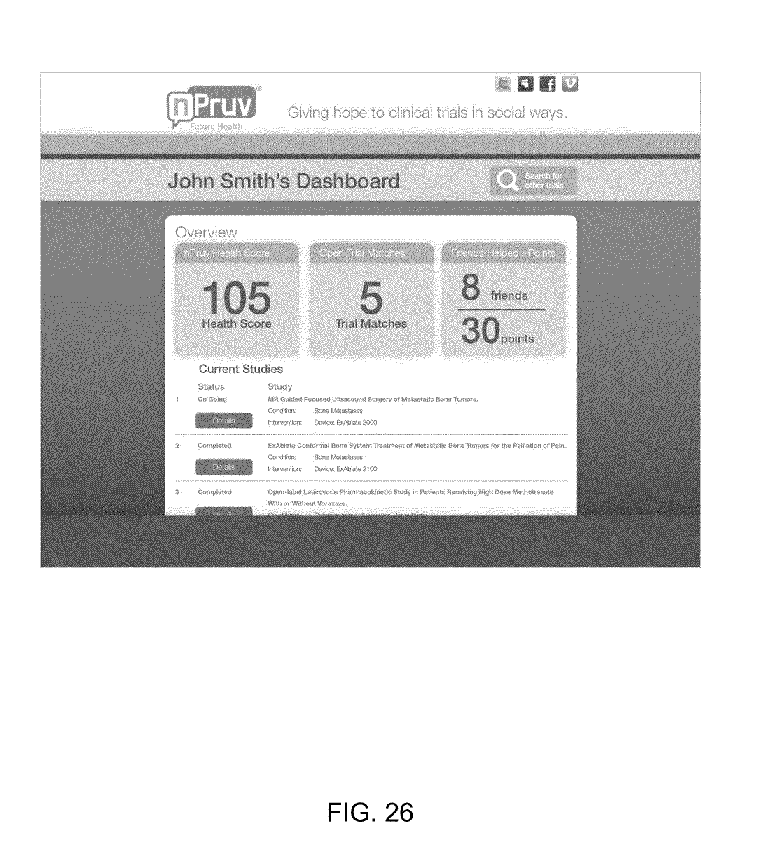

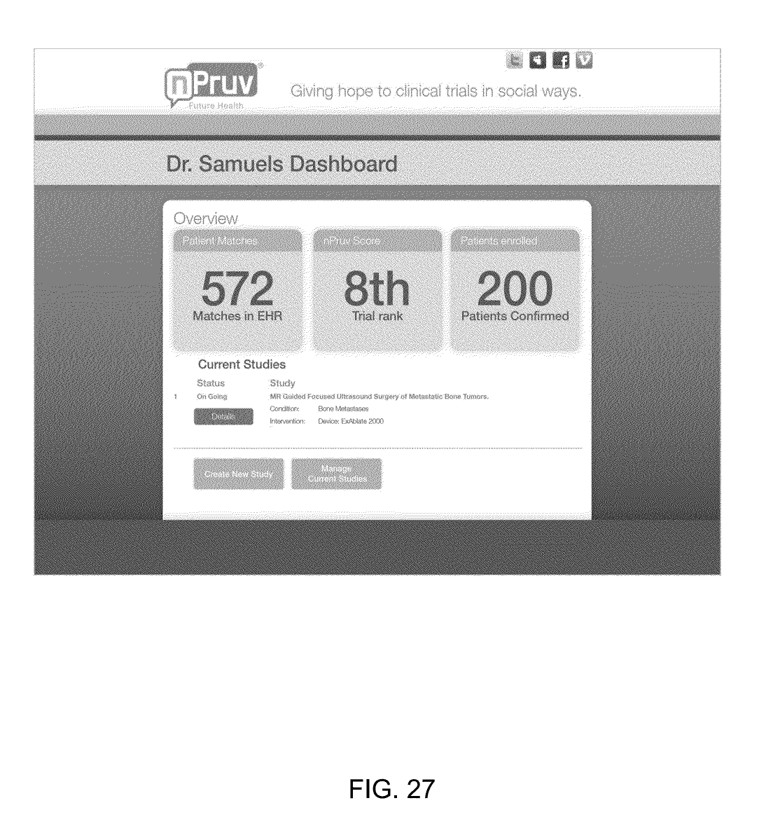

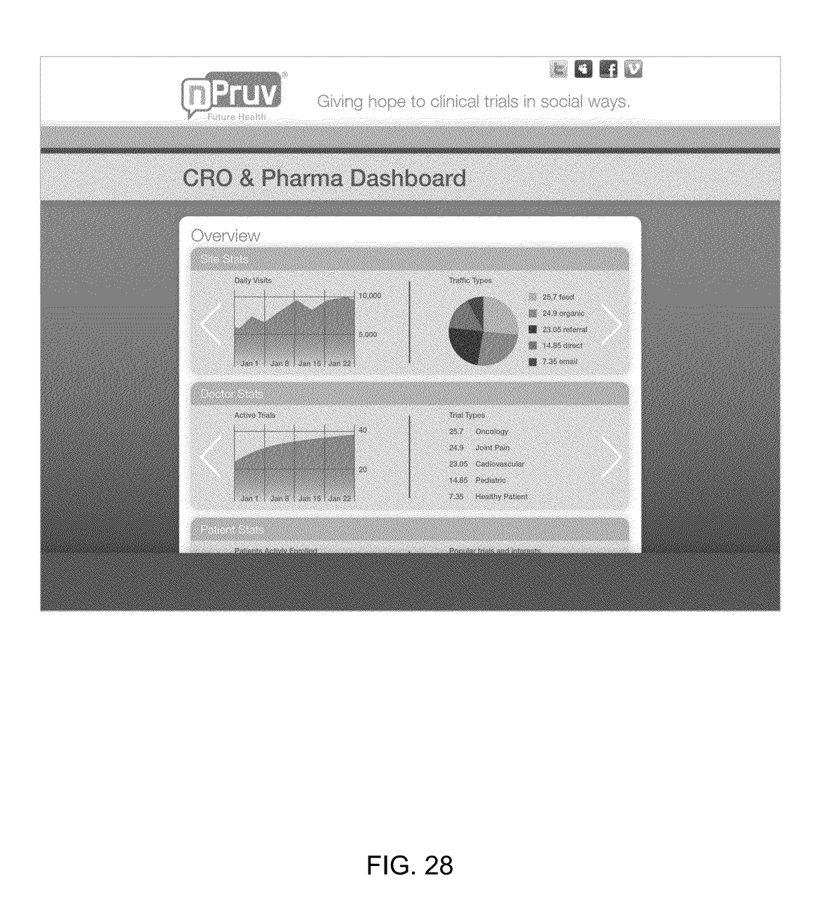

FIGS. 26 and 27 illustrate dashboards that may be provided for a patient (FIG. 26) or physician investigator (FIG. 27) to illustrate the relevant information on the trials, matches, contacts and other information relevant to their participation in the matching system. The patients and physicians may be rated and ranked based on relevant reviews of their performance in the clinical trials. FIG. 28 illustrates an overall CRO/Pharma Dashboard that gives an overview of one or more clinical trials being sponsored by the CRO, including statistics on the types of interest being generated by the match system, the PI, doctor and patient statistics of their candidates and matches, etc., in order to help evaluate the usefulness of their clinical trial and the matching being provided.

### Patient Services

Once a user is enrolled in the clinical trial recruitment system, additional information may be provided to the user, such as analytics on their medical data, coaching and tips for improving their health, and even cautions and warnings for potential side effects or risks of combining incompatible treatments or drugs. Additionally, the patient may be provided with offers for new drugs, treatments, devices, health insurance, patient groups, etc. based on their medical information and the clinical trials they have participated in. The user may also be asked to participate in evaluating the clinical trial and those involved in the clinical trial, in order to provide rankings of the best companies or doctors in the clinical trial industry.

### Clinical Trial Physician Training

In one embodiment, the patient recruitment system may be adapted to provide training for physicians that host clinical trials. The information obtained from patient evaluations and other patient data relating to clinical trials may be used as a basis for a course which provides education to physicians for conducting successful clinical trials. If a physician completes the course, they may be given a special designation on the website that candidate patients will see when evaluating a particular clinical trial.

### Computer-Implemented Embodiment

FIG. 11 is a block diagram that illustrates an embodiment of a computer/server system 300 upon which an embodiment of the inventive methodology may be implemented. The system 300 includes a computer/server platform 301 including a processor 302 and memory 303 which operate to execute instructions, as known to one of skill in the art. The term “computer-readable storage medium” as used herein refers to any tangible medium, such as a disk or semiconductor memory, that participates in providing instructions to processor 302 for execution. Additionally, the computer platform 301 receives input from a plurality of input devices 304, such as a keyboard, mouse, touch device or verbal command. The computer platform 301 may additionally be connected to a removable storage device 305, such as a portable hard drive, optical media (CD or DVD), disk media or any other tangible medium from which a computer can read executable code. The computer platform may further be connected to network resources 306 which connect to the Internet or other components of a local public or private network. The network resources 306 may provide instructions and data to the computer platform from a remote location on a network 307. The connections to the network resources 306 may be via wireless protocols, such as the 802.11 standards, Bluetooth® or cellular protocols, or via physical transmission media, such as cables or fiber optics. The network resources may include storage devices for storing data and executable instructions at a location separate from the computer platform 301. The computer interacts with a display 308 to output data and other information to a user, as well as to request additional instructions and input from the user. The display 308 may therefore further act as an input device 304 for interacting with a user.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

We claim:

1. A method for recruiting and matching patients with clinical trials, comprising:
recruiting one or more patients for participation in a clinical trial;
evaluating the compatibility of the one or more patients with the clinical trial and generating a compatibility score;
evaluating the compliance of the one or more patients with the clinical trial and generating a compliance score; and
determining whether the one or more patients should be enrolled in the clinical trial based on the compatibility score and compliance score.
